(19) United States
(12) Patent Application Publication
(10) Pub. No.: US 2010/0062800 A1
(43) Pub. Date: Mar. 11, 2010

(54) WIRELESS COMMUNICATIONS USING MULTIPLE RADIO ACCESS TECHNOLOGIES SIMULTANEOUSLY

(75) Inventors: Lalit Gupta, Bangalore (IN); Sanil S. Mathew, Thrissur (IN); Pramod K. Shrivastava, Bangalore (IN)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 12/206,150

(22) Filed: Sep. 8, 2008

(51) Int. Cl. H04M 1/00; H04B 7/00

(52) U.S. Cl. 455/552.1; 370/310

(57) ABSTRACT

In one embodiment, a wireless device communicates an uplink data stream to a wireless network using two radio access technologies (RATs) simultaneously. The wireless device has a host controller unit that segments the uplink data stream and provides each of the segmented portions to either a first baseband module corresponding to a first RAT or a second baseband module corresponding to a second RAT. The first baseband module modulates the data that it receives using the first RAT and provides the modulated data to a first radio frequency (RF) module. The second baseband module modulates the data that it receives using the second RAT and provides the modulated data to a second RF module. The first and second RF modules convert the modulated data to RF and provide the RF signals to first and second antennas, respectively. In alternative embodiments, more than two RATs are used simultaneously for communications.

### BACKGROUND OF THE INVENTION

1. Field of the Invention

The present invention relates to wireless communication systems that are capable of communicating using multiple radio access technologies.

2. Description of the Related Art

As developments in radio access technologies (RATs) have been made over the years, wireless communications service providers have updated their wireless networks in piecemeal fashion, resulting in wireless networks that operate using two or more RATs. Often, these RATs are disbursed throughout the network such that (i) some cells in the network operate using RATs that are different from the RATs used in other cells, and (ii) some cells operate using two or more RATs. To ensure that customers are able to communicate with the wireless network in most or all of these cells, service providers often provide their customers with multi-mode wireless communications devices that are capable of communicating with two or more different RATs.

FIG. 1 shows a simplified block diagram of one implementation of a prior-art multi-mode wireless communications device 100. Wireless communications device 100 may be a mobile phone, PDA, or any other suitable communications device. At any given time, wireless device 100 may communicate with a wireless communications network using one of two RATs. In this exemplary implementation, the first RAT adheres to the global system for mobile communications (GSM) standard and the second RAT adheres to the universal mobile telecommunications standard (UMTS).

Wireless device 100 has host controller unit (HCU) 102, which acts as the main controller for wireless device 100. HCU 102 may comprise one or more central processing units (CPUs). During transmission operations, HCU 102 receives uplink data from a user or a user application and selects a RAT to use for transmission. Selection of the RAT may be coordinated with the wireless network and may be based, for example, on measurements of signals received by wireless device 100 or the wireless network.

If HCU 102 selects the GSM standard for transmission, then the uplink data is provided to GSM baseband module 104. GSM baseband module 104 performs processing such as data symbol mapping, digital-to-analog (D/A) conversion, and other processing suitable for generating analog time-division multiple-access (TDMA) signals from the uplink data. If HCU 102 selects the UMTS standard for transmission, then the uplink data is provided to UMTS baseband module 106, which performs processing such as data symbol mapping, forward error correction (FEC) encoding, interleaving, multiplexing, rate matching, digital-to-analog (D/A) conversion, and other processing suitable for generating analog wideband code-division multiple-access (WCDMA) signals from the uplink data. The TDMA or WCDMA analog signals are then provided to radio frequency (RF) module 108, which converts the analog signals from baseband frequency to RF. The RF signals are then transmitted via antenna 110.

During receive operations, HCU 102 selects a RAT to use for receiving downlink signals from a wireless network. Similar to transmission operations, selection of the RAT for receiving is generally coordinated with the wireless network. Typically, transmission and reception operations are performed using the same standard, and thus, the selection of the RAT for transmitting and receiving may be combined.

At any given time, wireless device 100 receives either TDMA signals or WCDMA signals from the wireless network via antenna 110. RF module 108 processes the received TDMA or WCDMA signals using, for example, filtering, amplification, gain control, RF-to-baseband frequency conversion, or any other processing suitable for preparing the received signal for demodulation. If TDMA signals are received, then GSM baseband module 104 demodulates the signals using A/D conversion, equalization, synchronization, other processing suitable for demodulating received TDMA signals to recover the original downlink data. If WCDMA signals are received, then UMTS baseband module 106 demodulates the signals using A/D conversion, forward error correction (FEC) de-coding, de-interleaving, de-multiplexing, equalization, synchronization, and any other processing suitable for demodulating received WCDMA signals to recover the original downlink data. The demodulated signals are then provided to HCU 102, which provides the recovered downlink data to the user or user application.

### SUMMARY OF THE INVENTION

In one embodiment, the present invention is a first wireless communications device for transmitting a data stream to a second wireless communications device in a wireless communications network. The first device comprises a controller, first and second modulators, and first and second radio modules. The controller segments the data stream into at least first and second portions. The first modulator modulates the first portion according to a first radio access technology (RAT) and the second modulator modulates the second portion according to a second RAT. The first radio module and the second radio module simultaneously transmit the first modulated portion and the second modulated portion, respectively, to the second device.

In another embodiment, the present invention is a method for transmitting a data stream from a first wireless communications device to a second wireless communications device in a wireless communications network. The method segments the data stream into at least first and second portions. The first portion is modulated according to a first radio access technology (RAT) and the second portion is modulated according to a second RAT. The first and second modulated portions are then simultaneously transmitted from the first device to the second device.

In yet another embodiment, the present invention is a second wireless communications device for receiving a data stream transmitted from a first wireless communications device to the second wireless communications device in a wireless communications network. The second device comprises first and second radio modules, first and second modulators, and a controller. The first radio module receives a first modulated portion of the data stream transmitted from the first device to the second device and the second radio module receives a second modulated portion of the data stream transmitted from the first device to the second device. The first and second modulated portions correspond to different segments of the data stream. Further, the first modulated portion corresponds to a first segment modulated according to a first radio access technology (RAT), and the second modulated portion corresponds to a second segment modulated according to a second RAT. The first demodulator to demodulates the first portion according to the first RAT and the second demodulator to demodulates the second portion according to the second RAT. The controller then reassembles the first and second demodulated portions to recover the data stream.

In even yet another embodiment, the present invention is a method for receiving a data stream transmitted from a first wireless communications device to a second wireless communications device in a wireless communications network. The method simultaneously receives first and second modulated portions of the data stream transmitted from the first device to the second device. The first and second modulated portions correspond to different segments of the data stream. Further, the first modulated portion corresponds to a first segment modulated according to a first radio access technology (RAT), and the second modulated portion corresponds to a second segment modulated according to a second RAT. The first portion is demodulated according to the first RAT and the second portion is demodulated according to the second RAT. The first and second demodulated portions are then reassembled to recover the data stream.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of one implementation of a prior-art multi-mode wireless communications device;

FIG. 2 shows a simplified block diagram of a communication between a cellular station of a wireless communications network and a multi-mode wireless communications device according to one embodiment of the present invention;

FIG. 3 shows a simplified block diagram of the multi-mode wireless communication device of FIG. 2 according to one embodiment of the present invention;

FIG. 4 shows a simplified flow diagram of an algorithm that may be used by baseband modules of the wireless device of FIG. 3 to synchronize reporting of measurements to the host controller unit (HCU) of FIG. 3 according to one embodiment of the present invention;

FIG. 5 shows a simplified flow diagram of an algorithm that may be used by the HCU of FIG. 3 to synchronize the reporting of measurements from the two or more baseband modules of FIG. 3 according to one embodiment of the present invention;

FIG. 6 shows a simplified flow diagram of an algorithm that may be used by the baseband modules of FIG. 3 to synchronize reporting of data to the HCU of FIG. 3 according to one embodiment of the present invention;

FIG. 7 shows a simplified flow diagram of an algorithm that may be used by the HCU of FIG. 3 to synchronize reporting of data from the two or more baseband modules of FIG. 3 according to one embodiment of the present invention; and

FIG. 8 shows a simplified flow diagram of an algorithm that may be used to select one or more radio access technologies for transmission and reception.

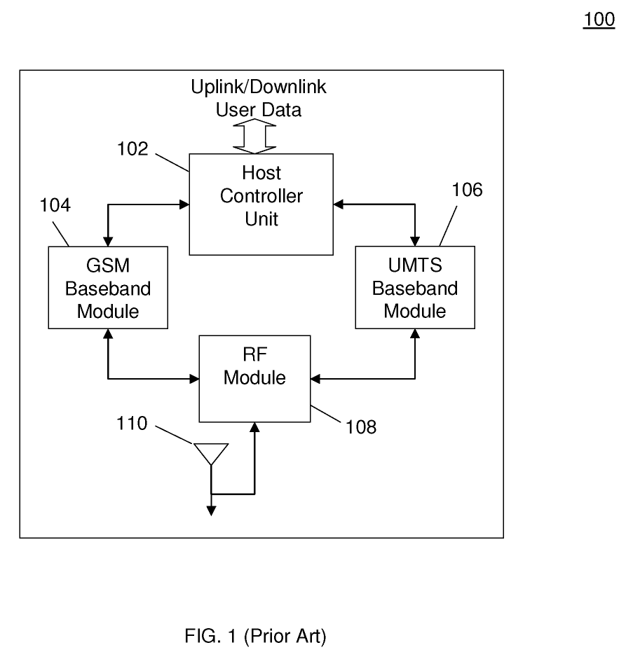

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Wireless Communications Using Multiple Radio Access Technologies Simultaneously

Wireless communications networks that have two or more radio access technologies (RATs) and that perform each communication using only one RAT at a time do not fully exploit the full bandwidth that is available to all RATs used by the network. For example, in some instances, one RAT alone might not be capable of achieving quality of service (QoS) guarantees such as guaranteed data rates, delays, and bit-error rates. To overcome possible QoS deficiencies and to improve throughput capabilities of prior-art wireless communications networks, a wireless communications network may be envisioned that is capable of performing a communication using more than one RAT at a time.

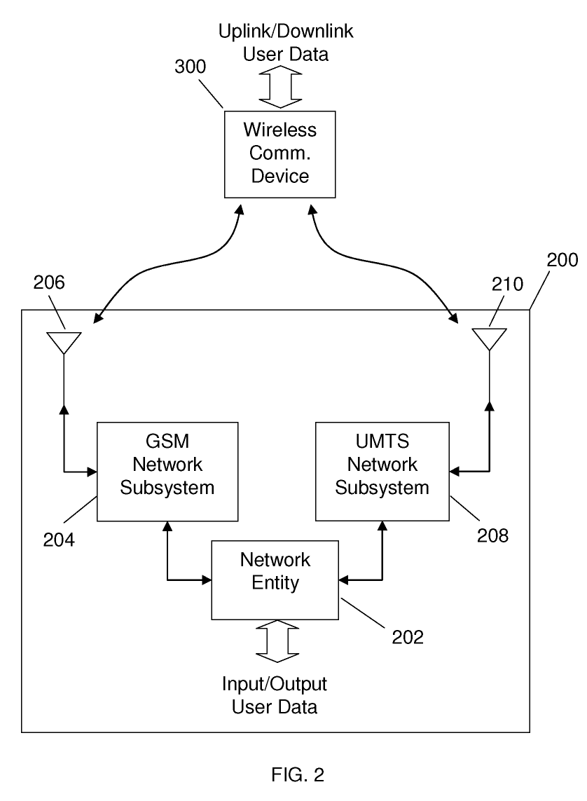

FIG. 2 shows a simplified block diagram of a communication between a cellular station 200 of a wireless communications network and a multi-mode wireless communications device 300 according to one embodiment of the present invention. At any given time, cellular station 200 may communicate with wireless device 300 using a first radio access technology (RAT) adhering to the global system for mobile communications (GSM) standard, a second RAT adhering to the universal mobile telecommunications standard (UMTS), or a combination of both the first and second RATs simultaneously. The particular standard or standards selected for transmitting and receiving are generally coordinated with wireless device 300, and may be based, for example, on (i) measurements of signals received by wireless device 300, (ii) measurements of signals received by the wireless network, (iii) QoS requirements of a particular user application, and (iv) QoS capabilities of the RATs that are available to both cellular station 200 and wireless device 300. Note that the particular RAT or RAT combination selected for transmitting might not be the same as that for receiving.

In the downlink direction (i.e., from wireless network to wireless device), network entity 202 receives a downlink data stream from a user or user application. If one standard is selected for transmitting, either the GSM standard or the UMTS standard, then network entity 202 may allocate all of the downlink data to the selected standard. If both standards are selected for transmitting, then network entity 202 may (i) segment the downlink data stream and allocate portions of the downlink data stream to the GSM standard and the UMTS standard such that no segmented portion is allocated to more than one standard or (ii) copy the downlink data stream such that one or more copies are allocated to two or more standards. The segmented portions may be allocated evenly between GSM and UMTS or may be allocated unevenly such that a larger percentage of the downlink data is allocated to either GSM or UMTS. Segmenting may be performed using, for example, a protocol similar to the IETF proposed protocol identified as request for comments (RFC) 1990 by Sklower et al., titled “The PPP Multilink Protocol (MP),” August 1996 (hereinafter referred to as RFC 1990), the teachings of which are herein incorporated by reference in their entirety. The multilink protocol is based on a link control protocol (LCP) option negotiation that permits a system to indicate to its peer that it is capable of combining multiple physical links into a “bundle.” The system offering the option is capable of combining multiple independent links between a fixed pair of systems, providing a virtual link with greater bandwidth than any of the constituent members. Note that there may be some differences from the PPP multilink protocol. For example, the link control protocol (LCP) and authentication control protocol might not be used for establishing radio links. Further, the technique for determining that a fragment is lost might be different than that of in RFC 1990.

Downlink data allocated to the GSM standard is encoded by GSM network subsystem 204 to generate time-division multiple-access (TDMA) encoded signals that are transmitted to wireless device 300 via antenna 206. Downlink data allocated to the UTMS standard is encoded by UMTS network subsystem 208 to generate wideband code-division multiple-access (WCDMA) encoded signals that are transmitted to wireless device 300 via antenna 210.

In the uplink direction (i.e., from wireless device to wireless network), cellular station 200 receives TDMA encoded signals from wireless device 300 via antenna 206 and WCDMA encoded signals from wireless device 300 via antenna 210. If the GSM standard is selected for receiving, then the received TDMA signals are processed by GSM network subsystem 204 to recover the original uplink data stream that was generated at wireless device 300. The uplink data stream recovered by GSM network subsystem 204 is provided to network entity 202, which outputs the uplink data stream to a user or user application. Similarly, if the UMTS standard is selected for receiving, then the WCDMA signals are processed by UMTS network subsystem 208 to recover the original uplink data that was generated at wireless device 300. The uplink data stream recovered by UMTS network subsystem 208 is provided to network entity 202, which outputs the uplink data stream to a user or user application. If both the GSM and UMTS standards are selected for receiving TDMA and WCDMA signals simultaneously, then the uplink data streams recovered by both GSM network subsystem 204 and UMTS network subsystem 208 are reassembled or combined by, for example, network entity 202 to recover the fully assembled uplink data stream that was generated at wireless device 300. The recovered uplink data stream is then output to the user or user application.

According to one configuration of cellular station 200, GSM network substation 204 may be a base station subsystem (BSS), UMTS network subsystem 208 may be a radio network subsystem (RNS), and network entity 202 may be a serving GPRS support node (SGSN). According to another configuration of cellular station 200, GSM network substation 204 may comprise a BSS and SGSN, UMTS network subsystem 208 may comprise an RNS and SGSN, and network entity 202 may be comprise a gateway GPRS support node (GGSN).

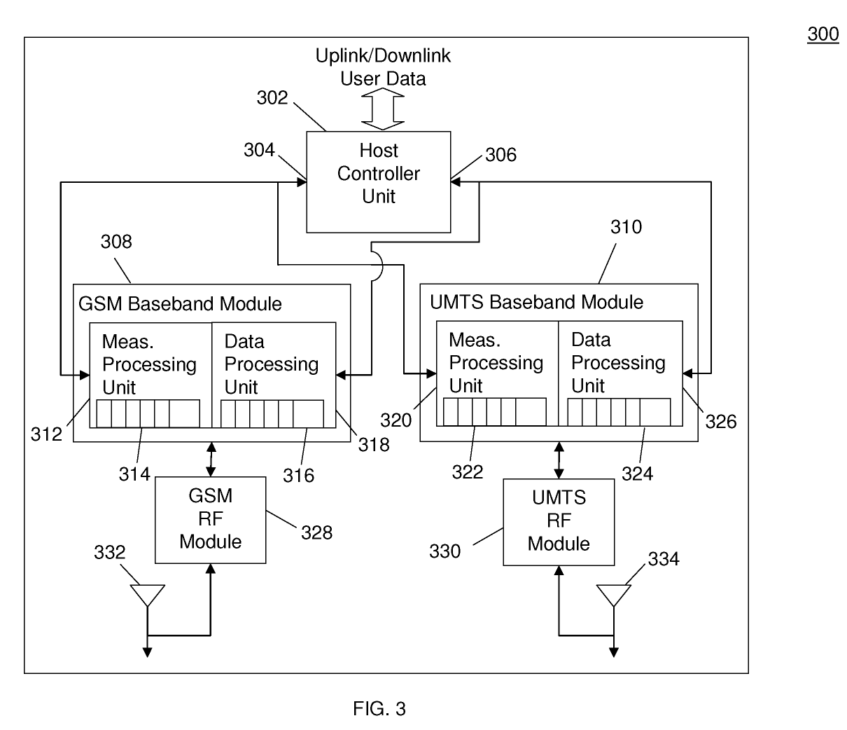

FIG. 3 shows a simplified block diagram of multi-mode wireless communication device 300 of FIG. 2 according to one embodiment of the present invention. Wireless device 300 may be a mobile phone, PDA, or any other suitable communications device. At any given time, wireless device 300 may communicate with cellular station 200 of FIG. 2 using the GSM standard, the UMTS standard, or both the GSM and UMTS standards simultaneously.

Wireless device 300 has host controller unit (HCU) 302, which operates as the main controller for wireless device 300. HCU 302 may comprise one or more central processing units (CPUs) and has two interfaces: measurement interface 304 and data interface 306. Data processing unit 318 of GSM baseband module 308 and data processing unit 326 of UMTS baseband module 310 are coupled to HCU 302 via data interface 306. Measurement processing unit 312 of GSM baseband module 308 and measurement processing unit 320 of UMTS baseband module 310 are coupled to HCU 302 via measurement interface 304. As described below, GSM and UMTS baseband modules 308 and 310 are modulator/demodulators that modulate outgoing data and demodulate incoming modulated signals based on their corresponding RAT.

In the uplink direction, HCU 302 receives an uplink data stream from the user or user application and selects one or more RATs to use for transmission. Selection of the one or more RATs may be coordinated with the wireless network and may be based, for example, on (i) measurements of signals received by wireless device 300, (ii) measurements of signals received from wireless device 300 by the wireless network, (iii) QoS requirements of a particular user application, and (iv) QoS capabilities of the RATs that are available to both wireless device 300 and the wireless network for transmission. If only one RAT (i.e., GSM or UMTS) is selected for transmission, then the uplink data is allocated to the selected RAT. If two RATs (i.e., both GSM and UMTS) are selected, then the uplink data stream may be (i) segmented such that some portions of the uplink data stream are allocated to the GSM standard and other portions of the uplink data stream are allocated to the UMTS standard, or (ii) copied such that the uplink data stream is allocated to both standards. The segmented portions may be allocated evenly between GSM and UMTS or may be allocated unevenly such that a larger percentage of the uplink data is allocated to either GSM or UMTS. Segmenting may be performed using, for example, a protocol similar to the PPP multilink protocol for wired internet applications specified in RFC 1990 as discussed above in relation to cellular station 200 of FIG. 2.

HCU 302 generates data packets based on any portions of the uplink data stream allocated to GSM and provides these data packets to GSM data processing unit 318 along with packet information such as the length of each data packet and the sequence number of each data packet. Similarly, HCU 302 generates data packets based on any portions of uplink data stream allocated to UMTS and provides these data packets to UMTS data processing unit 326 along with packet information such as the length of each data packet and the sequence number of each data packet. The sequence numbers may be used by baseband modules 308 and 310 for providing statuses of transmission to HCU 302.

Data packets received by GSM data processing unit 318 are processed using, for example, data symbol mapping, digital-to-analog (D/A) conversion, and other processing suitable for generating analog time-division multiple-access (TDMA) encoded signals from the data packets. The TDMA analog signals are provided to GSM radio frequency (RF) module 328, a radio module that converts the TDMA analog signals from baseband frequency to RF. The RF TDMA signals are then transmitted to the network via antenna 332.

Data packets received by UMTS data processing unit 326 are processed using, for example, data symbol mapping, forward error correction (FEC) encoding, interleaving, multiplexing, rate matching, D/A conversion, and other processing suitable for generating an analog wideband code-division multiple-access (WCDMA) encoded signal from the data packets. The WCDMA analog signals generated by UMTS data processing unit 326 are provided to UMTS RF module 330, a radio module that converts the WCDMA analog signals from baseband frequency to RF. The WCDMA RF signals are then transmitted to the wireless network via antenna 334.

During downlink receive operations, wireless device 300 receives TDMA signals via antenna 332 and WCDMA signals via antenna 334. TDMA signals are processed by GSM RF module 328 using, for example, filtering, amplification, gain control, RF-to-baseband frequency conversion, or any other processing suitable for preparing a received TDMA signal for demodulation. The baseband TDMA signals are provided to GSM data processing unit 318. WCDMA signals are processed by UMTS RF module 330 using filtering, amplification, gain control, RF-to-baseband frequency conversion, or any other processing suitable for preparing the received WCDMA signal for demodulation. The baseband WCDMA signals are provided to UMTS data processing unit 326.

GSM data processing unit 318 demodulates baseband TDMA signals using analog-to-digital (A/D) conversion, equalization, synchronization, or other processing suitable for demodulating TDMA signals to recover the original downlink data packets generated at the wireless network. UMTS data processing unit 326 demodulates WCDMA signals using A/D conversion, FEC decoding, deinterleaving, demultiplexing, WCDMA demodulation, equalization, synchronization, or other processing suitable for demodulating received WCDMA signals to recover the original downlink data packets generated at the wireless network. The data packets recovered by GSM data processing unit 318 and UMTS data processing unit 326 are provided to HCU 302 along with packet information, such as the length of each data packet and the sequence number of each data packet.

If both GSM and UMTS are selected for simultaneous receiving, then the downlink data packets recovered by GSM data processing unit 318 and UMTS data processing unit 326 may be provided to HCU 302 in a synchronized manner. This may be accomplished by storing downlink data packets recovered by GSM data processing unit 318 in data buffer 316 while HCU 302 processes downlink data packets recovered by UMTS data processing unit 326, and by storing downlink data packets recovered by UMTS data processing unit 326 in data buffer 324 while HCU 302 processes downlink data packets recovered by GSM data processing unit 318. HCU 302 then reassembles the downlink data packets received from GSM data processing unit 318 and UMTS data processing unit 326 and provides the original downlink data stream that was generated at the wireless network to the user or user application.

Upon receiving TDMA and WCDMA signals, wireless device 300 also generates measurements of the received signals. HCU 302 communicates measurement control information to measurement processing units 312 and 320 via measurement interface 304. The measurement control information may comprise information such as the particular types of measurements to be reported by the baseband units, triggers to initialize reporting of measurement quantities to HCU 302, timers for reporting of these quantities, and modifications to previously generated measurements.

Measurement processing unit 312 generates measurements of the baseband TDMA signals received by GSM baseband module 308 and receives measurements generated by GSM RF module 328. These measurements, which may include, for example, received signal strength indications (RSSI) and initial basic signal identification codes (BSIC), are reported to HCU 302 via measurement interface 304.

Measurement processing unit 320 generates measurements of WCDMA signals received by wireless device 300 and receives measurements generated by UMTS RF module 330. These measurements, which may include, for example, received signal code power (RSCP), received signal strength indications (RSSI), received energy per chip divided by the power density in the band (Ec/No), estimation of the transport channel block error rate (BLER), and total user equipment (UE) transmitted power on one carrier, are also reported to HCU 302 via measurement interface 304.

When wireless device 300 receives both TDMA and UMTS signals simultaneously, the reporting of these measurements may be synchronized such that HCU 302 does not receive the measurements from measurement processing units 312 and 320 simultaneously. This may be accomplished by storing measurements generated by GSM measurement processing unit 312 in buffer 314 while HCU 302 processes measurements generated by UMTS measurement processing unit 320, and by storing measurements generated by UMTS measurement processing unit 320 in buffer 322 while HCU 302 processes measurements generated by GSM measurement processing unit 312.

HCU 302 generates measurement reports based on the measurements received from measurement processing units 312 and 320. These measurement reports may be used by HCU 302 and the wireless network to make decisions such as (i) whether communications between wireless device 300 and the wireless network should be switched to a neighboring cell in the wireless network, and (ii) whether communications between wireless device 300 and the wireless network should be performed using the GSM standard, the UMTS standard, or both the GSM and UMTS standards.

While the present invention has been described relative to communications using two RATs, the present invention is not so limited. The present invention may be used for communications that involve more than two RATs and may also be used with combinations of RATs other than GSM and UMTS. For example, the present invention may also be used with WIFI, CDMA 2000, OFDM, and other suitable RATs that are used in wireless communications.

Further, while communications using two or more RATs simultaneously were described as occurring between a wireless communications device and a single cellular station, the present invention is not so limited. A multi-mode wireless communications device of the present invention may communicate with two or more cellular stations of a wireless network, wherein communications with each cellular station is performed using a RAT that is different from communications performed with the other cellular stations. For example, wireless device 300 may communicate with a GSM network subsystem such as GSM network subsystem 204 that is located in a first cell and a UMTS network subsystem such as UMTS network subsystem 208 that is located in a second cell. In that case, downlink data segmenting and uplink data reassembling is orchestrated by the network infrastructure.

Yet further, various embodiments of the present invention may be envisioned in which the TDMA and WCDMA signals are transmitted and/or received simultaneously from one antenna rather than two separate antennas. For example, GSM RF module 328 and UMTS RF module 330 of wireless device 300 may provide uplink signals to and receive downlink signals from a single antenna rather than both antennas 332 and 334.

Synchronizing Measurement Reporting to the Host Controller Unit (HCU)

Synchronization problems may arise when two or more measurement processing units attempt to access a single HCU concurrently. For example, suppose that HCU 302 of wireless device 300 of FIG. 3 receives measurements from GSM measurement processing unit 312. HCU 302 processes these measurements, makes decisions about whether to switch communications to another cellular station, and generates measurement reports to provide to the wireless network. If HCU 302 receives measurements from UMTS measurement processing unit 320 before HCU 302 has finished processing the measurements from GSM measurement processing unit 312, then HCU 302 could start processing the measurements from UMTS measurement processing unit 320 prematurely causing an unpredictable result. To prevent problems that may arise when an HCU attempts to process measurements from multiple baseband modules concurrently, the reporting of measurements from multiple baseband modules to an HCU may be synchronized.

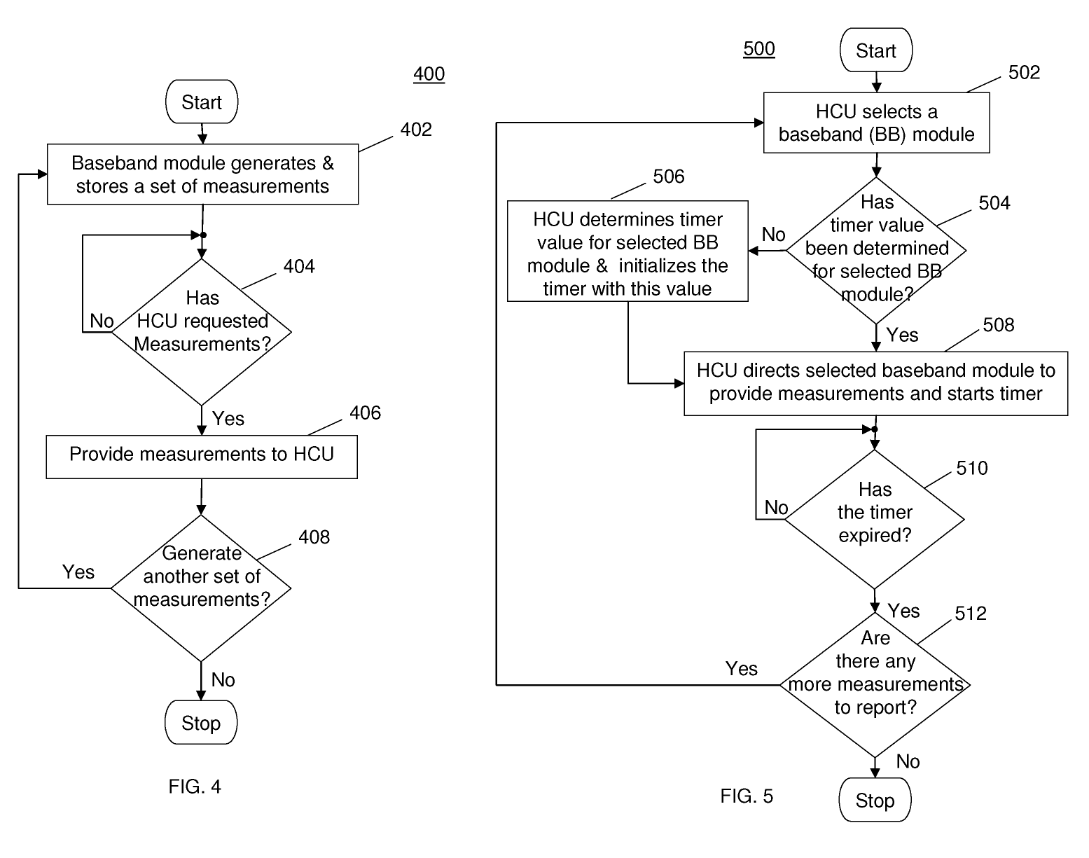

FIG. 4 shows a simplified flow diagram of an algorithm 400 that may be used by baseband modules to synchronize the reporting of measurements to an HCU according to one embodiment of the present invention. Algorithm 400, which is used in conjunction with algorithm 500 of FIG. 5 described below, may be implemented at each baseband module of a wireless device. For example, suppose that a first implementation of algorithm 400 is employed by GSM baseband module 308 of wireless device 300 of FIG. 3 and a second implementation of algorithm 400 is employed by UMTS baseband module 310 of wireless device 300. The first and second implementations of algorithm 400 may be run simultaneously by GSM baseband module 308 and UMTS baseband module 310, respectively, such that measurements of received TDMA and WCDMA signals are generated at the same time. Note, however, as discussed below in relation to FIG. 5, the measurements are not provided from the two baseband modules to HCU 302 at the same time.

Upon receipt of TDMA and WCDMA signals, measurement processing unit 312 of GSM baseband module 308 generates a set of measurements based on the TDMA signals, stores the set of measurements in buffer 314 (step 402), and then waits for HCU 302 to request the stored measurements. Once the set of measurements is requested (step 404), GSM baseband module 308 provides the measurements to HCU 302 (step 406). If wireless device 300 continues to receive TDMA signals (step 408), then GSM baseband module 308 continues to generate measurements and steps 402 to 408 are repeated. Such measurements may be stopped, for example, when the wireless network directs GSM baseband module 308 to stop generating measurements.

Similarly, upon receipt of a WCDMA signal measurement processing unit 320 of UMTS baseband module 310 generates a set of measurements based on the WCDMA signals and stores the measurements in buffer 322 (step 402). Once the set of measurements is requested (step 404) from UMTS baseband module 310, the measurements are provided to HCU 302 (step 406). If wireless device 300 continues to receive WCDMA signals (step 408), then UMTS baseband module 310 continues to generate measurements and steps 402 to 408 are repeated. Once wireless device 300 stops receiving WCDMA signals, measurement generation by UMTS baseband module 310 is stopped.

FIG. 5 shows a simplified flow diagram of an algorithm 500 that may be used to synchronize the reporting of measurements from two or more baseband modules to the HCU according to one embodiment of the present invention. Algorithm 500 may be implemented at an HCU and may be used in conjunction with algorithm 400 of FIG. 4. For example, suppose that algorithm 500 is implemented at HCU 302 of wireless device 300 of FIG. 3. Upon startup, step 502 selects a baseband module (e.g., either GSM baseband module 308 or UMTS baseband module 310) for initialization. Step 504 determines whether a timer value has been determined for the selected baseband module. If no timer has been determined, as is typically the case upon startup, then HCU 302 determines a timer value for the selected baseband module and initializes a timer within HCU 302 with this timer value (step 506). The timer value corresponds to the amount of time that it takes for HCU 302 to process the measurements received from a baseband unit, and there may be a different timer value for each RAT employed.

Once the timer value for the selected baseband module has been determined, HCU 302 (i) directs the selected baseband module to provide the measurements stored on its buffer (e.g., buffer 314 or 322) and (ii) starts the timer (step 508). While the timer is running, HCU 302 processes the measurements. Once the timer expires (step 510) processing of the measurements by HCU 302 is finished. HCU 302 then determines if there are any further sets of measurements to report (step 512). If there are further sets of measurements to report, then HCU 302 selects another baseband module (step 502) and repeats steps 504 to 512 for the newly selected baseband module. If there are no further sets of measurements to report, then HCU 302 stops requesting sets of measurements from the baseband modules.

While the present invention has been described relative its use with wireless device 300 of FIG. 3, the present invention is not so limited. The present invention may be implemented in wireless devices other than wireless device 300 to synchronize reporting of measurements generated by two or more baseband modules that employ two or more radio access technologies. In such embodiments, algorithm 400 may be implemented for each baseband module.

Various embodiments of the present invention may be envisioned in which synchronization of measurement reporting is performed at either (i) the baseband modules or (ii) the HCU, rather than at both the baseband modules and the HCU. For example, according to some embodiments, the baseband modules may take turns providing measurements to the HCU. In such embodiments, a token may be passed between the baseband modules. When a baseband module receives the token, it provides measurements to the HCU. When the baseband module has finished providing measurements, it may pass the token to the next baseband module. In this case, an algorithm such as algorithm 500 of FIG. 5 that is implemented at the HCU might not be necessary.

Further embodiments of the present invention may be envisioned in which the measurements of the baseband modules are generated in succession rather than simultaneously. In such embodiments, the timer values may correspond to the amount of time that it takes for a baseband module to generate a set of measurements. For example, for wireless device 300, two timer values could be determined, one for the amount of time that it takes GSM measurement processing unit 312 to generate a set of measurements, and one for the amount of time that it takes UMTS measurement processing unit 320 to generate a set of measurements. Upon startup, the timer for a first measurement unit (i.e., either GSM measurement processing unit 312 or UMTS measurement processing unit 320) would be started and the first measurement processing unit would begin generating measurements. Once the timer expires, generation of the set of measurements is complete. The first measurement processing unit provides the set of measurements to HCU 302, and the second measurement processing unit is directed to start its timer. Once the timer expires for the second measurement processing unit, the set of measurements generated by the second measurement processing unit is provided to HCU 302, and the first measurement processing unit is directed to start its timer. This process is repeated while wireless device 300 is receiving TDMA and WCDMA signals. Note that, according to such further embodiments, buffers such as buffers 314 and 322 might not be needed to store the measurements since measurements are not generated simultaneously by the baseband modules.

Synchronizing Data Reporting to the Host Controller Unit (HCU)

Synchronization problems may also arise when two or more data processing units attempt to access a single HCU concurrently. For example, suppose that HCU 302 of wireless device 300 of FIG. 3 receives data from GSM data processing unit 318 and then subsequently receives data from UMTS data processing unit 326 before HCU 302 has completed processing the data from GSM data processing unit 318. In this case, HCU 302 could start processing the data from UMTS data processing unit 326 prematurely causing the data to be incorrectly reassembled or combined. To prevent problems that may arise when an HCU attempts to process data from multiple baseband modules concurrently, the reporting of data from multiple baseband modules to an HCU may be synchronized. Unlike measurement processing, however, the amount of time that it takes for data processing unit 318 and data processing unit 326 to process data may vary over time. Thus, synchronization of data reporting is preferably not performed using timers.

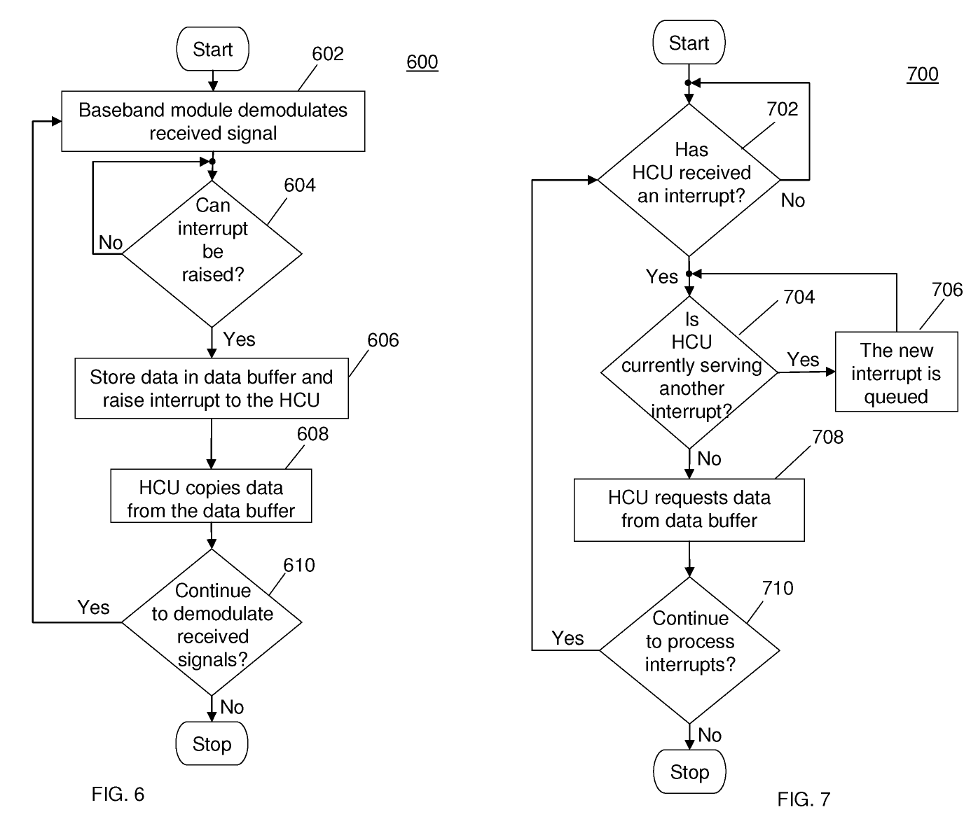

FIG. 6 shows a simplified flow diagram of an algorithm 600 that may be used by baseband modules to synchronize the reporting of data to an HCU according to one embodiment of the present invention. Algorithm 600, which is used in conjunction with algorithm 700 of FIG. 7 discussed below, may be implemented at each baseband module of a wireless device. For example, suppose that a first implementation of algorithm 600 is employed by GSM baseband module 308 of wireless device 300 of FIG. 3 and a second implementation of algorithm 600 is employed by UMTS baseband module 310 of wireless device 300. The first and second implementations of algorithm 600 may be run simultaneously by GSM baseband module 308 and UMTS baseband module 310, respectively, such that received TDMA and WCDMA signals are demodulated at the same time. Note, however, as discussed below in relation to FIG. 7, the data recovered from these baseband modules are not reported to HCU 302 at the same time.

Upon receipt of a TDMA signal, data processing unit 318 of GSM baseband module 308 demodulates the TDMA signal (step 602) and determines whether an interrupt can be raised to HCU 302 (step 604). If data that was previously demodulated is already stored in data buffer 316, then data processing unit 318 does not raise an interrupt. In this case, buffer 316 might not be large enough to store both the previously demodulated data and the current demodulated data. However, if no previously demodulated data is stored in data buffer 316, then the current demodulated data is stored in data buffer 316 and GSM baseband module 308 raises an interrupt to HCU 302 (step 606). Once HCU 302 requests the stored data, GSM baseband module 308 provides the stored data to HCU 302 (step 608). If GSM baseband module 308 continues to receive TDMA signals (step 610), then GSM baseband module 308 repeats steps 602 to 610. Once all received TDMA signals have been processed, algorithm 600 is stopped.

Similarly, upon receipt of a WCDMA signal, data processing unit 326 of UMTS baseband module 310 demodulates the WDMA signal (step 602). UMTS baseband module 310 then determines whether an interrupt can be raised to HCU 302 as described above (step 604). If an interrupt can be raised, then data processing unit 326 raises the interrupt to HCU 302 and stores the current demodulatd data in data buffer 324 (step 606). Upon request by HCU 302, the stored demodulated data is provided to HCU 302 (step 608). This process is repeated while UMTS baseband module 310 continues to receive WCDMA signals.

FIG. 7 shows a simplified flow diagram of an algorithm 700 that may be used to synchronize reporting of data from two or more baseband modules to an HCU according to one embodiment of the present invention. Algorithm 700, which is used in conjunction with algorithm 600 of FIG. 6, may be implemented at an HCU. For example, suppose that algorithm 700 is implemented at HCU 302 of wireless device 300 of FIG. 3.

Upon startup, HCU 302 waits for an interrupt to be received from either GSM baseband module 308 or UMTS baseband module 310 (step 702). If HCU 302 is currently serving a previously received interrupt from another baseband module (step 704), then the newly received interrupt is queued (step 706). In this case, the baseband module corresponding to the newly received interrupt continues to store the recovered data until HCU 302 has finished processing the previously received interrupt. If HCU 302 is not currently serving a previously received interrupt or once HCU 302 has completed processing a previously received interrupt, HCU 302 requests the stored data from the baseband module corresponding to the newly received interrupt (step 708). This process is repeated for each interrupt received from GSM baseband module 308 and UMTS baseband module 310 (step 710). If no new interrupts are generated, then algorithm 700 is stopped.

While the present invention has been described relative its use with wireless device 300 of FIG. 3, the present invention is not so limited. The present invention may be implemented in wireless devices other than wireless device 300 to synchronize reporting of data demodulated by two or more baseband modules that employ two or more radio access technologies. In such embodiments, algorithm 600 may be implemented for each baseband module.

Various embodiments of the present invention may be envisioned in which the synchronization of data reporting is performed at either (i) the baseband modules or (ii) the HCU, rather than at both the baseband modules and the HCU. For example, according to some embodiments, the baseband modules may take turns providing demodulated data to the HCU. In such embodiments, a token may be passed between the baseband modules. When a baseband module receives the token, it provides demodulated data to the HCU. When the baseband module has finished providing data, it may pass the token to the next baseband module. In this case, an algorithm such as algorithm 700 of FIG. 7 implemented at the HCU might not be necessary.

Selecting One or More Radio Access Technologies (RATs) for Communications

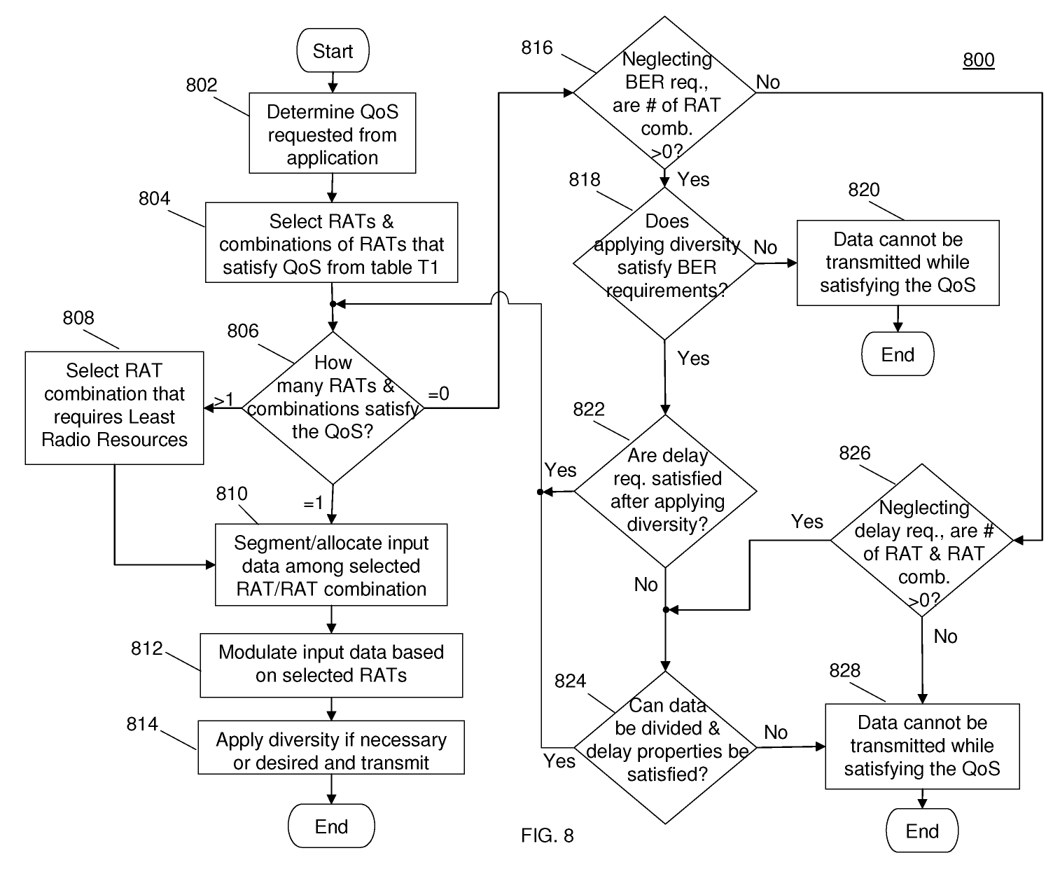

FIG. 8 shows a simplified flow diagram of an algorithm 800 that may be used to select one or more RATs for transmission and reception. Algorithm 800 may be implemented, for example, at a host controller unit (HCU) of a wireless communications device such as HCU 302 of wireless device 300 of FIG. 3. Upon startup, step 802 determines the quality of service (QoS) that is needed for transmitting an uplink data stream received from a user or user application. The QoS may be obtained from, for example, the user application itself.

After the QoS is determined, a first table T1 is searched to determine whether one or more RATs may be used to satisfy the QoS (Step 804). Table T1, which may be derived through experimentation, may be stored at each cellular station and may vary from one cellular station to the next. This table comprises a list of RATs that may be used to communicate with the wireless device. The list may include (i) RATs employed by the cellular station in the cell where the wireless device is located, (ii) RATs employed by adjacent cellular stations that may be used to communicate with the wireless device, (iii) and possible combinations of two or more of the RATs. Additionally, for each RAT or RAT combination, table T1 stores the QoS capabilities and the radio resources that are expended when the RAT or RAT combination is used. The radio resources may be, for example, a particular frequency, a time slot on a particular frequency, a code used on a particular frequency, or other resources related to spectrums that governments sell to service providers. When algorithm 800 is implemented at the wireless communications device, Table T1 may be transmitted to the wireless device, for example, by broadcast.

If the total number of possible RAT and RAT combinations that may be used to satisfy the QoS is equal to one (step 806), then the input data stream is allocated to the selected RAT or RAT combination (step 810). In the case that a combination of two or more RATs satisfies the QoS, the input data stream is segmented. Segmenting may be performed using a protocol similar to the PPP multilink protocol for wired internet applications specified in rfc1990, as described above. The segmented portions of the uplink data stream are then allocated to the RATs such that no portion is allocated to more than one RAT. For example, when wireless communications device 300 of FIG. 3 segments an uplink data stream, portions of the uplink data stream are allocated to the GSM standard and other portions of the uplink data are allocated to the UMTS standard. Each segmented portion is then modulated based on the RAT to which it was allocated (step 812). If necessary or desired, the uplink data may be transmitted using a diversity technique (step 814).

If the total number of possible RAT and RAT combinations that may be used to satisfy the QoS is greater than one (step 806), then algorithm 800 selects one possible RAT or RAT combination to use for transmission and reception. In particular, the RAT or RAT combination that uses the least amount of radio resources is selected from table Ti (step 808). For example, suppose that, for a transmission by wireless device 300 of FIG. 3, the QoS may be satisfied using either (i) the UMTS standard only or (ii) a combination of both the UMTS standard and the GSM standard. In this case, the UMTS standard may be selected over the combination because the UMTS standard by itself generally uses fewer radio resources than UMTS and GSM combined. Selecting the RAT or RAT combination that uses the fewest radio resources may be desirable, especially in wireless communications devices, to reduce power consumption. Once a RAT or RAT combination is selected, steps 810 to 814 are performed as described above.

If the total number of possible RATs and RAT combinations that may be used to satisfy the QoS is equal to zero (step 806), then algorithm 800 determines whether certain measures may be taken to enable one or more RAT or RAT combinations to satisfy the QoS. First, step 816 considers whether the number of RAT or RAT combinations that satisfy the QoS is greater than zero if the bit-error-rate (BER) requirements are neglected. If the number of combinations is greater than zero, then it is likely that the failure to satisfy the QoS is a result of BER requirements. In this case, step 818 determines if the BER requirements may be satisfied using transmit diversity techniques. This determination may be made, for example, using a second table T2 that lists the BER for each RAT and RAT combination when diversity techniques are used and when diversity techniques are not used. When diversity techniques are employed, the BER may be reduced by (i) performing soft combining on the redundant signals received by the receiver or (ii) choosing the correct version of a received signal from one or more received redundant signals.

If applying diversity techniques does not satisfy the BER requirements, then the data cannot be transmitted while satisfying the QoS (step 820). In this case, several actions could be taken. For example, the uplink data stream could be transmitted automatically at a reduced QoS, the user could receive a notice to accept a lower QoS, or the uplink data stream might not be sent at all in the event that the user does not wish to run the application at a reduced QoS. If applying diversity techniques does satisfy the BER requirements, then step 822 determines whether the delay requirements would be satisfied when the diversity techniques are applied. This determination may be made, for example, using a third table T3 that lists the delay for each RAT or RAT combination when diversity techniques are used and when diversity techniques are not used. Applying diversity techniques may increase the delay because the receiver might have to wait for a redundant signal to be received.

If the delay requirements are satisfied for one or more RAT and RAT combinations, then step 806 determines how many RAT or RAT combinations satisfy the QoS when diversity is applied. If the number of RAT or RAT combinations is greater than one, then steps 808 to 814 are performed as described above. If the number of RAT or RAT combinations is equal to one, then steps 810 to 814 are performed as described above. If the delay requirements are not satisfied for one or more RAT and RAT combinations when diversity is applied, then step 824 determines whether the input data can be segmented in a manner such that the delay properties are satisfied. This determination may be made, for example, using a fourth table T4 that lists the delay for each RAT or RAT combination when different data packet lengths are used. Generally, reducing the packet length reduces the delay.

If the delay requirements may be satisfied for one or more RAT and RAT combinations by selecting proper data packet lengths, then step 806 determines how many RAT or RAT combinations satisfy the QoS when diversity techniques and reduced packets lengths are employed. If the number of RAT or RAT combinations is greater than one, then steps 808 to 814 are performed as described above. If the number of RAT or RAT combinations is equal to one, then steps 810 to 814 are performed as described above. If the delay requirements cannot be satisfied for one or more RAT and RAT combinations by selecting proper data packet lengths, then the data cannot be transmitted while satisfying the QoS (step 828). In this case, several actions may be taken as described above in relation to step 820.

Referring back to step 816, if the number of RAT or RAT combinations that satisfy the QoS is not greater than zero when the bit-error-rate (BER) requirements are neglected, then the failure to satisfy the QoS may be a result of something other than BER requirements. Step 826 considers whether the number of RAT or RAT combinations that satisfy the QoS is greater than zero if the delay requirements are neglected. If the number of combinations is greater than zero, then it is likely that the failure to satisfy the QoS is a result of the delay requirements. In this case, step 824 is performed to determine whether the delay requirements may be met by reducing the packet length, as described above. If the number of combinations is still equal to zero, then it is likely that the failure to satisfy the QoS is a result of a failure to meet the data rate requirements. In this case, the data cannot be transmitted while satisfying the QoS (step 828) and several actions may be taken as described above in relation to step 820.

While the present invention was discussed relative to its use with a HCU of a wireless communications device such as HCU 302, the algorithm 800 is not so limited. Various embodiments of the present invention may also be implemented at a network entity of a wireless communications network such as network entity 202 of FIG. 2 to select one or more RATs to use for transmission or reception. In such embodiments, a downlink data stream is processed rather than an uplink data stream as described above in relation to algorithm 800.

Throughout the specification and the claims, the term “simultaneously” is used to describe the performance of two or more operations, each of which has a start time, a performance duration during which the operation is performed, and an end time. The use of the term “simultaneously” in the specification and claims refers to the performance of the two or more operations in a manner such that their performance durations overlap. Accordingly, it is not necessary that the two or more operations have the same start times and/or the same end times.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

For purposes of this description, the terms “couple” or “coupled” refer to any manner known in the art or later developed in which energy is allowed to be transferred between two or more elements, and the interposition of one or more additional elements is contemplated, although not required.

We claim:

1. A first wireless communications device for transmitting a data stream to a second wireless communications device in a wireless communications network, the first device comprising:
a controller adapted to segment the data stream into at least first and second portions;
a first modulator adapted to modulate the first portion according to a first radio access technology (RAT);
a second modulator adapted to modulate the second portion according to a second RAT;
a first radio module adapted to transmit the first modulated portion; and
a second radio module adapted to transmit the second modulated portion, wherein the first and second radio modules are adapted to simultaneously transmit the first and second modulated portions to the second device.

2. The invention of claim 1, wherein the first and second RATs conform to two different industry standards.

3. The invention of claim 2, wherein:
the first RAT conforms to a GSM standard; and
the second RAT conforms to a UMTS standard.

4. The invention of claim 1, wherein:
the first device is a cellular station of the network; and
the second device is a multi-mode wireless communications device.

5. The invention of claim 1, wherein:
the first device is a multi-mode wireless communications device; and
the second device is a cellular station of the network.

6. The invention of claim 1, wherein the controller is adapted to determine whether to transmit the data stream using (i) a combination of both the first and second RATs or (ii) only one of the first and second RATs.

7. The invention of claim 6, wherein the determination is based on:
a desired quality of service (QoS) level for transmitting the data stream; and
QoS capabilities of each of (1) the first device operating using the combination of both the first and second RATs, (2) the first device operating using only the first RAT, and (3) the first device operating using only the second RAT.

8. The invention of claim 6, wherein the determination as to whether to transmit the data stream using (i) the combination of both the first and second RATs or (ii) only one of the first and second RATs is based on a desired throughput for transmitting the data stream.

9. The invention of claim 1, wherein:
the controller is adapted to segment the data stream into at least first, second, and third portions;
the first device further comprises:
a third modulator adapted to modulate the third portion according to a third RAT; and
a third radio module adapted to transmit the third modulated portion; and
the controller is adapted to determine whether to transmit the data stream using (i) a combination of both the first and second RATs, (ii) a combination of both the first and third RATs, or (iii) a combination of both the second and third RATs.

10. The invention of claim 9, wherein the determination is based on:
a desired quality of service (QoS) level for transmitting the data stream; and
QoS capabilities of each of (1) the first device operating using the combination of both the first and second RATs, (2) the first device operating using the combination of both the first and third RATs, and (3) the first device operating using the combination of both the second and third RATs.

11. The invention of claim 10, wherein the determination is further based on an amount of radio resources expended by each of (1) the first device operating using the combination of both the first and second RATs, (2) the first device operating using the combination of both the first and third RATs, and (3) the first device operating using the combination of both the second and third RATs.

12. A method for transmitting a data stream from a first wireless communications device to a second wireless communications device in a wireless communications network, the method comprising:
(a) segmenting the data stream into at least first and second portions;
(b) modulating the first portion according to a first radio access technology (RAT);
(c) modulating the second portion according to a second RAT; and
(d) simultaneously transmitting the first and second modulated portions from the first device to the second device.

13. A second wireless communications device for receiving a data stream transmitted from a first wireless communications device to the second wireless communications device in a wireless communications network, the second device comprising:
a first radio module adapted to receive a first modulated portion transmitted from the first device to the second device;
a second radio module adapted to receive a second modulated portion transmitted from the first device to the second device, wherein:
the first and second modulated portions correspond to different segments of the data stream;
the first modulated portion corresponds to a first segment modulated according to a first radio access technology (RAT); and
the second modulated portion corresponds to a second segment modulated according to a second RAT;
a first demodulator adapted to demodulate the first portion according to the first RAT;
a second demodulator adapted to demodulate the second portion according to the second RAT; and
a controller adapted to reassemble the first and second demodulated portions to recover the data stream.

14. The invention of claim 13, wherein the first and second RATs conform to two different industry standards.

15. The invention of claim 14, wherein:
the first RAT conforms to a GSM standard; and
the second RAT conforms to a UMTS standard.

16. The invention of claim 13, wherein:
the first device is a cellular station of the network; and
the second device is a multi-mode wireless communications device.

17. The invention of claim 13, wherein:
the first device is a multi-mode wireless communications device; and
the second device is a cellular station of the network.

18. The invention of claim 13, wherein:
the first modulator is further adapted to generate a first set of measurements based on the first portion;
the second modulator is further adapted to generate a second set of measurements based on the second portion; and
the controller processes only one of the first and second sets of measurements at a time.

19. The invention of claim 13, wherein the controller processes only one of the first and second demodulated portions at a time.

20. A method for receiving a data stream transmitted from a first wireless communications device to a second wireless communications device in a wireless communications network, the method comprising:
(a) simultaneously receiving first and second modulated portions transmitted from the first device to the second device, wherein:
the first and second modulated portions correspond to different segments of the data stream;
the first modulated portion corresponds to a first segment modulated according to a first radio access technology (RAT); and
the second modulated portion corresponds to a second segment modulated according to a second RAT;
(b) demodulating the first portion according to the first RAT;
(c) demodulating the second portion according to the second RAT; and
(d) reassembling the first and second demodulated portions to recover the data stream.
